(19) United States
(12) Patent Application Publication
(10) Pub. No.: US 2004/0022596 A1
(43) Pub. Date: Feb. 5, 2004

(54) Fastener having integral drive nut

(76) Inventor: Joseph D. Belanger, Huntington Beach, CA (US)

Correspondence Address: Robert H. Earp, III, McDonald, Hopkins, Burke & Haber, 2100 Bank One Center, 600 Superior Avenue, Cleveland, OH, 44114, US

(21) Appl. No.: 10/208,630

(22) Filed: Jul. 30, 2002

(51) Int. Cl. F16B 13/04

(52) U.S. Cl. 411/34

(57) ABSTRACT

A fastener having an integral drive nut includes a fastener body having a body head and an axial bore therethrough, a corebolt passing through the fastener body bore and having an outer end thereof extending above the body head, and an integral drive nut and cap nut assembly thereon. The drive nut is configured to fit around the outer end of the corebolt and in contact with the body head to restrain the fastener body from turning during rotation of the corebolt. The cap nut is configured to connect to the corebolt and urge the drive nut into engagement with the fastener body head. Thus, by providing a simplified integral drive nut and cap nut assembly, robotic and manual installation of the fastener is greatly enhanced as the present invention utilizes a construction that does not require time consuming and costly fitting and drive nut changes.

### FIELD OF INVENTION

The present invention relates generally to blind fasteners for use in fastening workpieces together in overlapped outer and inner relation, and more particularly, to blind fasteners of different sizes that utilize a universal retention and driving assembly to permit rapid installation of the blind fasteners without necessity to change the wrench bits of the installation tool.

### BACKGROUND OF THE INVENTION

Blind fasteners are commonly used to join two workpieces together where access is only available through one of the surfaces.

One type of blind fastener shown in U.S. Pat. No. 4,747,202 issued May 31, 1988, and currently owned by the assignee of the present application, generally comprises an internally threaded fastener body, for insertion into aligned holes of the two workpieces, having an externally threaded cylindrical corebolt passing in threaded engagement therethrough. The inserted inner end of the corebolt has an enlarged corebolt head mounted thereon with a wrench engaging portion at the outer end of the corebolt. Upon rotation of the corebolt relative to the fastener body, the corebolt moves in an axial outward direction through the fastener body causing the corebolt head to deform a sleeve located around the corebolt and between the inner portion of the fastener body and the corebolt head. The sleeve deforms around the inner portion of the fastener body to a fully set condition against the inner workpiece. The corebolt may further be provided with a localized weakened region or break groove adapted to shear the corebolt at a predetermined torque. The break groove preferably is located axially along the corebolt such that the corebolt shears in substantially flush relation to the outer portion of the fastener body, i.e., the fastener body head. The fastener body head normally is received in a countersunk, flush relationship to the outer workpiece, thus providing an aerodynamic surface after the fastener is set.

A second type of blind fastener shown in U.S. Pat. No. 5,634,751 issued Jun. 3, 1997, and currently owned by the assignee of the present application, generally comprises a fastener body having an unthreaded axial bore for insertion into aligned holes of the workpieces and a cylindrical corebolt having an externally threaded inner portion extending therethrough. The corebolt includes a wrench engaging portion at its outer end and engages a nut have a threaded bore at its inner end. Upon rotation of the corebolt relative to the fastener body, the nut is threaded urged in an axial outward direction causing the nut to deform a sleeve located around the corebolt and between the inner portion of the fastener body and the nut. The sleeve deforms around the inner portion of the fastener body to a fully set condition against the inner workpiece.

Regardless of the type of blind fastener utilized, as the corebolt is turned through the fastener body, some means must be provided for preventing rotation of the fastener body inside the workpieces. One approach, shown in the '202 patent, involves mounting an internally threaded drive nut onto the corebolt in abutment with the outer surface of the fastener body head. The drive nut is held stationary by an appropriately configured fitting on the installation tool. The drive nut creates a frictional resistance for resisting turning slippage between abutting surfaces or is provided with deformable ridges which engage the fastener body head during rotation of the corebolt by the rotary wrench bit. Another approach, shown in the '751 patent, comprises providing a plurality of notches in the fastener body head for engagement by an installation tool having a non-rotating nosepiece fitting that is inserted into the notches. The fitting holds the fastener body against rotation, while a rotary wrench bit of the installation tool fits over the wrench engaging region and turns the corebolt through the fastener body.

However, it is known that various sized fasteners may be used to connect workpieces depending upon several factors, such as the size and composition of the two workpieces. For example, heavy, thick workpieces generally require a larger sized fastener than lightweight, thin workpieces. Therefore, as the size and composition of the workpieces varies, so does the size of the fastener. This includes variations in the dimensions of the fastener body, corebolt, and drive nut. Installation of difference sized fasteners, therefore, require an installation tool having different sized nosepiece fittings and a different sized rotary wrench bit for each size fastener. When various size fasteners are installed in a particular work area, which is not uncommon when assembling structural members, for example, of an aircraft, the installer constantly may be required to use several installation tools, each one having a fitting and a wrench bit dimensioned for a particular size fastener. If access to several tools is not possible, the installer frequently may be required to change the fittings and wrench bits of the installation tool. This process is time consuming and inconvenient.

If robotic installation of the fastener is contemplated, the time consuming problem of having to manually change components of the installation tool tends to undermine the reason for using robotic installation in the first place. Another related problem associated with robotic installation is that it may be difficult for the robotic installation tool to align with and engage the drive nut and wrench engaging region of the corebolt. This is also a consideration when using hand held installation tools. Most drive nuts are hexagonal in cross-section, while the wrench engaging region of most corebolts comprise wrenching flats. Depending upon the sophistication and mechanical capabilities of the robotic installation tool, the tool may not permit sufficient rotational adjustment of the nosepiece fitting and rotary wrench bit to align with and fit over the drive nut and wrenching flats, respectively. This poses additional time consuming problems and inconvenience.

Accordingly, there exists a need for a blind fastener that, despite its variation in sizes, may be installed by manual or robotic installation tools without having to change the drive nuts and wrench components of the tools each time a fastener of differing size is used. There further exists a need for a method of installing blind fasteners of different sizes without the necessity of changing the fittings and wrench components of the installation tool. The present invention satisfies these needs and provides further related advantages.

### BRIEF SUMMARY OF THE INVENTION

Therefore, it is an object of the present invention to provide a fastener that may be installed by manual or robotic installation tools without having to change the drive nuts and wrench components of the tools each time a fastener of differing size is used.

It is a further objection of the present invention to provide a method of installing blind fasteners of different sizes without the necessity of changing the fittings and wrench components of the installation tool.

These objects are achieved through providing a fastener generally comprising a fastener body having a body head and an axial bore therethrough, a corebolt passing through the fastener body bore and having an outer end thereof extending above the body head, and an integral drive nut having an axial unthreaded bore therethrough, the drive nut configured to fit around the outer end of the corebolt and in contact with the body head to restrain the fastener body from turning during rotation of the corebolt.

The present invention makes it possible to use robots or manual means to hold the drive nut in place while simultaneously rotating the corebolt to engage the fastener. Thus, by providing a simplified integral drive nut and cap nut assembly, robotic and manual installation of the faster is greatly enhanced as the present invention utilizes a construction that does not require time consuming and cost fitting and drive nut changes.

The present invention will be more fully described in the following written description with reference to the accompanying drawings.

### BRIEF DESCRIPTION OF THE SEVERAL VIEWS OF THE DRAWING

FIG. 1 is an assembled, perspective view of the fastener of the present invention.

FIG. 2 is an exploded view of the fastener showing the components thereof.

FIG. 3 is a cross sectional view of the fastener as inserted within a pair of workpieces to be clamped together prior to the application of torque for setting the fastener.

FIG. 4 is cross sectional view of the fastener in FIG. 3 after torque has been applied and the fastener is in its fully set condition.

FIG. 5 is a cross sectional view of the fastener of FIG. 4 showing the removal of the integral drive nut and cap nut assembly after fully setting the fastener and shearing of the corebolt.

### DETAILED DESCRIPTION OF THE INVENTION

As shown in the exemplary drawings, the present invention is embodied preferably in a blind fastener connecting two workpieces together in overlapped outer and inner relation. The fastener includes an integral drive nut that permits fasteners having various size requirements to utilize the same or similar drive nut and cap nut configurations so as to simplify the installation of different sized fasteners without the necessity to change the tool's wrench bits. The present invention is particularly useful for installing different sized fasteners using the same robotic tooling. The blind fastener of the present invention furthermore is simple to install, reliable in use, and relatively inexpensive to manufacture.

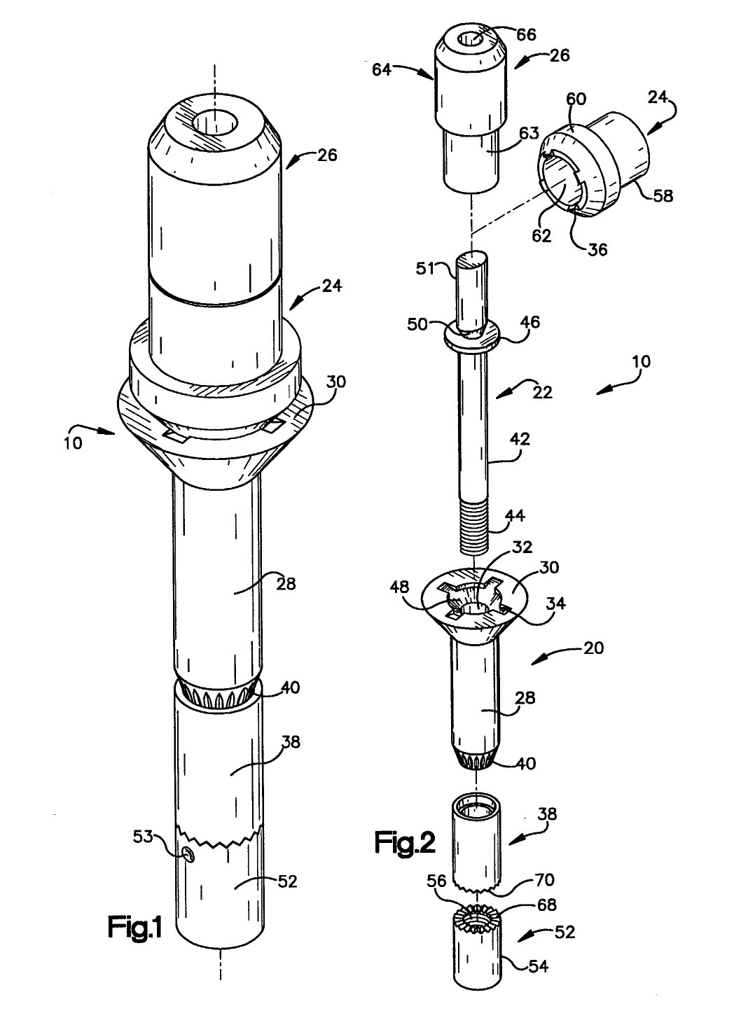

Referring to the FIGS. 1 through 5, a fastener of the present invention, generally designated 10, is shown for connecting two workpieces 12,14 together in overlapped outer and inner relation, with the outer workpiece 12 having an accessible outer surface 16 and the inner workpiece 14 having an inaccessible or blind inner surface 18. The terms inner and outer are used throughout this disclosure where “inner” is used to indicate the direction toward the fastener end nut 52 and “outer” is used to indicate the direction toward the fastener cap nut 26.

As particularly shown in FIGS. 1 and 2, fastener 10 generally comprises a fastener body 20, a corebolt 22 passing therethrough for engaging the fastening mechanism, an integral drive nut 24 configured to fit around the outer end of the corebolt 22 (called a pintail 51) and in contact with the fastener body 20 to restrain it from turning during rotation of the corebolt 22, and a cap nut 26 mounted to the outer end of the pintail 51 and urging the drive nut 24 into contact with the fastener body 20.

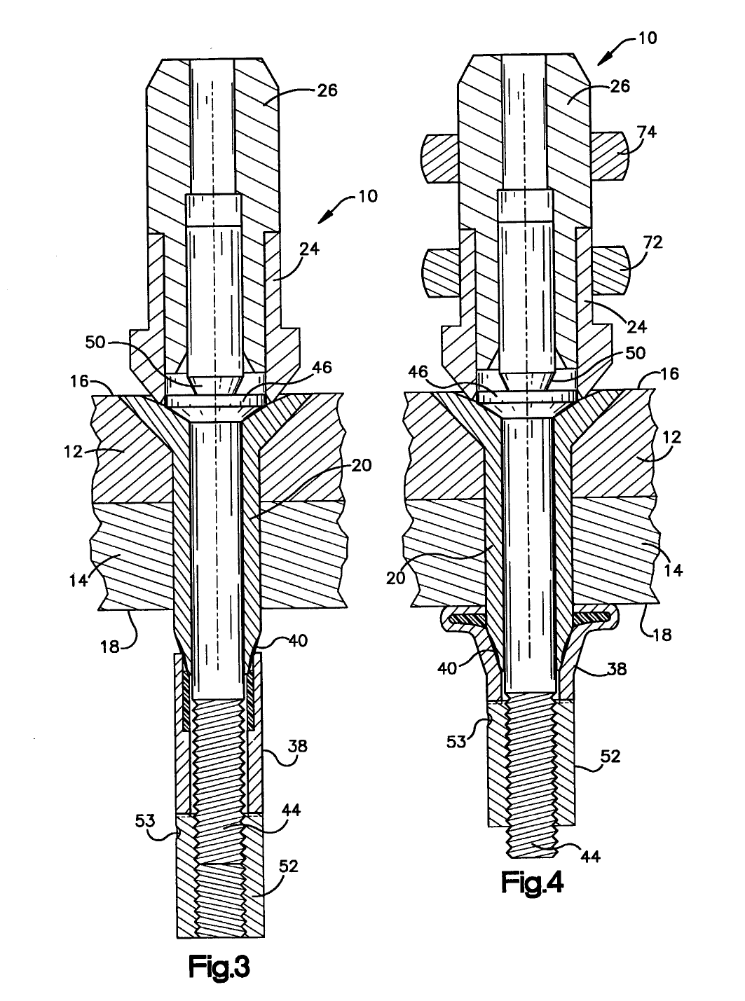

With continued reference to FIG. 1, fastener body 20 comprises a generally tubular body 28 having a head 30 at its outer end and having an unthreaded axial bore 32 therethrough. The size and configuration of the head 30 can be any size as required by the application, i.e. hexagonal, round, square, etc. The head shape may further be flat or conical so as to rest atop the outer surface of the outer workpiece or in a countersunk relationship therewith. And although any head configuration that engages the outer surface 16 of the outer workpiece 12 is acceptable, it is preferred the fastener body 20 have an enlarged head 30 received in a substantially flush, countersunk relationship to the outer surface of the outer workpiece. As shown in FIGS. 3 through 5, the preferred embodiment of fastener 10 includes a fastener body 20 having an enlarged head 30 of frustro-conical shape capable of nested engagement with a corresponding frustro-conical portion in the outer surface 16 of the outer workpiece 12. Such nested engagement permits the mounting of the fastener 10 in a flush condition with the outer surface 16 of the outer workpiece 12 as best shown in FIG. 5.

Continuing with FIG. 1, the head 30 includes at least one notch 34 formed on its outer surface to engage at least one projection 36 extending from the inner portion of the drive nut 24 (described below), to prevent rotation of the fastener body 20 when the drive nut 24 is held stationary. However, it is preferred that the head 30 include four equally spaced notches 34 for receiving four equally spaced projections 36 extending from the drive nut 24 to prevent rotation of the fastener body 20 when the drive nut 24 is held stationary.

To ensure good contact between the fastener body 20 and the deformable sleeve 38, the inner end of the fastener body 20 includes a conically-shaped, knurled, inner end or tapered nose 40 that engages the outer end portion of the deformable sleeve 38 to prevent rotation of the deformable sleeve 38 during rotation of the corebolt 22 and assist in encouraging the deform able sleeve 38 to set against the inner surface 18 of the inner workpiece 14.

Corebolt 22 comprises a cylindrical portion 42 that rotates within the fastener body bore 32 and includes an externally threaded portion 44 at its inner end. As best shown in FIG. 3, the cylindrical portion 42 of the corebolt 22 located within the fastener body 20 is not threaded and does not threadedly engage the fastener body 20 as seen in the prior art. The portion of the corebolt 22 located within the fastener body 20 rotates freely within the fastener body 20 and the threaded portion 44 engages end nut 52 as described more completely below.

Continuing with FIG. 1, corebolt 22 also includes a shoulder 46 located intermediate its inner and outer ends that nests within a shoulder-receiving portion 48 in the fastener body head 30. Preferably, the shoulder 46 is frustro-conical in shape and nestedly fits within a corresponding frustro-conical shoulder-receiving portion 48 in the fastener body head 30 to provide a substantially flush surface when the fastener 10 is engaged. Corebolt 22 further includes a weakened portion or break groove 50 located circumferentially about the corebolt 22 and substantially flush with the surface of the shoulder 46 so that upon fully setting the fastener 10, pintail 51 shears off at the break groove 50 and the integral drive nut 24 and cap nut 26 are removed therefrom as shown in FIG. 5 and described more completely below. The outermost portion of the corebolt 22 is called the pin-tail 51 which is received within the bore 66 of the cap nut 26 as described below. However, it is noted that the pintail 51 be of any shape which is receivable within the cap nut bore 66, i.e. elliptical, cylindrical, squared, etc.

As further shown in FIGS. 1 and 2, deformable sleeve 38 is configured to fit around the inner end of the corebolt 22 and in contact with the tapered nose 40. The deformable sleeve 38 comprises a material easily compressed in response to threaded engagement of the end nut 52. The tapered nose 40 of the fastener body 20 engages the inside diameter of the outer portion of the deformable sleeve 38 to prevent rotation of the deformable sleeve 38 during rotation of the corebolt 22 and assists the deformable sleeve 38 in engaging the inner surface 18 of the inner workpiece 14 during setting of the fastener 10. The deformable sleeve 38 also includes a knurled inner portion 70 that engages the knurled outer portion 68 of the end nut 52 so that rotation of the corebolt 22 does not cause rotation of the end nut 52.

The end nut 52 comprises a generally cylindrical sleeve 54 having a threaded bore 56 therethrough for engaging the threaded portion 44 of the corebolt 22. During assembly, the end nut 52 threadedly engages the threaded portion 44 of the corebolt 22 so as to be in contact with the deformable sleeve 38. To ensure proper contact between the end nut 52 and the deformable sleeve 38, the outer surface of the end nut 52 includes a knurled portion 68 that engages the corresponding knurled portion 70 of the deformable sleeve 38. Such contact is desirable so that upon holding the drive nut 24 stationary and rotating the corebolt 22, the contact between the end nut 52 and the deformable sleeve 38 permits the end nut 52 to be drawn along the threaded portion 44 of the corebolt 22 to force the deformable sleeve 38 into a fully set condition in overlying contact with the inner surface 18 of the inner workpiece 14. The end nut 52 may also include a thread lock to lock the end nut 52 to the externally threaded portion 44 of the corebolt 22 upon setting of the fastener so that the end nut 52 cannot unthread from the corebolt 22. Such a thread lock is preferably provided by “bumping” the end nut 52 circumferentially thereabout to cause a deformation 53 in the end nut 52 that acts as a wedge on the interior portion thereof to prevent the unthreading of the end nut 52 from the threaded portion 44 of the corebolt 22.

Drive nut 24 is assembled integrally with the fastener 10 so that various sized fasteners can utilize the same or similar sized drive nuts and cap nuts. Providing different sized fasteners having substantially similar or identical drive nut and cap nut exterior configurations permits a universal tool or robot to install such different sized fasteners without have to retool or change wrenching bits. Preferably the exterior configurations of the drive nut and cap nut are cylindrical. However, it is clear that the exterior configurations could be any shape corresponding to the installation tool requirements such as hexagonal, square, or any other shape. Again, depending on the installation tooling requirements, the cap nut and the drive nut do not necessarily have to be of the same configuration. Utilizing any such configurations, the bores therethrough would be configured to accommodate fasteners having different sized or shaped corebolts.

As best shown in FIG. 1, drive nut 24 comprises a generally cylindrical body 58 having a head 60 at its inner end and having an axial, unthreaded bore 62 therethrough. The drive nut 24 is configured to fit around the pintail 51 thereby permitting the pintail 51 to rotate within the drive nut bore 62. The outer surface of the drive nut 24 is preferably cylindrical for engagement by a non-rotating fitting on the installation tool or robotic tool, although other configurations are possible.

As described above, the drive nut 24 is in contact with the fastener body head 30 so that upon holding the drive nut 24 stationary, the stationary drive nut 24 restrains the fastener body 20 from turning within the workpieces during rotation of the corebolt 22. In order to promote good frictional contact between the integral drive nut 24 and the fastener body head 30, the drive nut 24 includes at least one downwardly extending projection 36 that engages at least one notch 34 on the fastener body head 30 to prevent the rotation of the fastener body 20 when the drive nut 24 is held stationary. Although drive nut 24 may have any number of projections 36 for engagement with any number of corresponding notches 34 in the fastener body head 30, the preferred embodiment utilizes four equally spaced projections 36 and notches 34 to ensure good contact between the drive nut 24 and the fastener body head 30.

As shown in FIG. 2, drive nut 24 may be manufactured having the appropriate number of projections 36 therein and assembled so that each projection 36 engages each notch 34. However, it is preferred that the drive nut have no projections formed therein during manufacture and that the inner portion of the head 60 comprise a relatively soft material such that upon pressfit installation of the cap nut 26 over the drive nut 24 and onto the pintai 51, the force of the press-fitting forces the drive nut 24 against the head 30 of the fastener body 20 so as to deform the inner portion of the drive nut to create projections 36 within the notches 34 of the fastener body head 30.

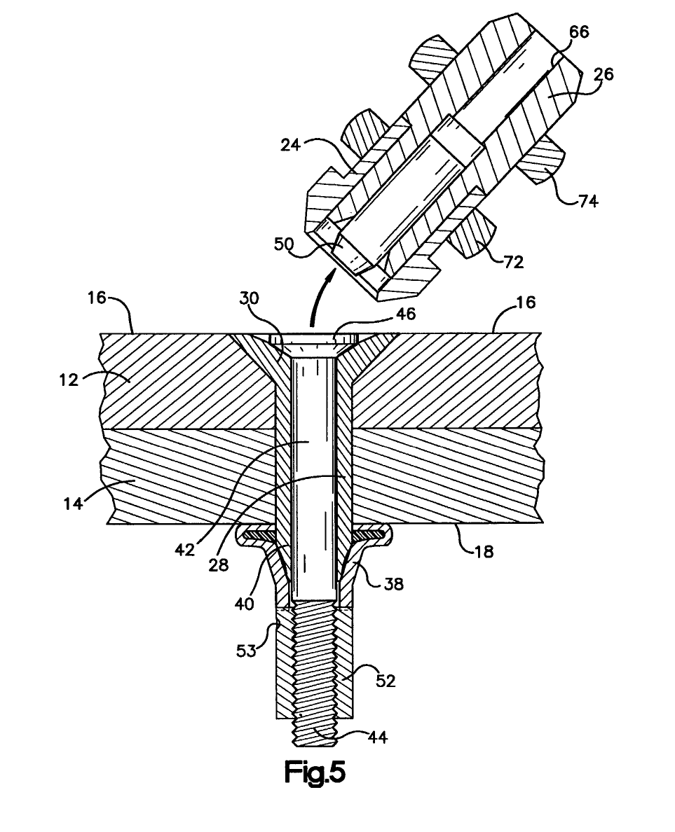

In order to maintain the drive nut 24 in proper alignment and contact with the fastener body head 30, and to provide a means for rotating the corebolt 22, a cap nut 26 is mounted to the outer end of the pintail 51 and urges the drive nut 24 into contact with the fastener body head 30 such as by press-fitting the cap nut 26 onto the outer end of the pintail 51. The cap nut 26 comprises a generally cylindrical body 63 and a generally larger diameter head 64 at its outer end. The head 64 includes a generally cylindrical outer surface for engagement by a wrenching means such as the rotary wrench bit of an installation tool or robotic tool. The cap nut 26 further has an axial, unthreaded bore 66 therethrough. As best shown in FIGS. 3 and 4, in assembly, the bore 66 of the cap nut 26 is press fit onto the pintail 51 of the corebolt 22 to provide engagement therebetween. It is again noted that the pintail 51 of the corebolt 22 can be of any cross-section shape to engage the corresponding bore in the cap nut.

The bore 66 of the cap nut 26 is preferably slightly small in diameter than the pin-tail 51 so that the components will engage during press-fitting. However, it is also possible that the bore 66 could taper outwardly through the cap nut 26 to provide the proper means for engaging the pintail 51 during press-fit construction. The inner portion of the cap nut 26 preferably telescopingly inserts into the inside diameter of the outer portion of the drive nut 24 and is then press fit onto the pin-tail 51 such that the cap nut 26 engages the pintail 51 and further urges the drive nut 24 into engagement with the fastener head 30. Therefore, turning of the cap nut 26 turns the corebolt 22 within the fastener 10.

It is preferable that the outer surfaces of the cap nut 26 and the drive nut 24 be generally cylindrical and further that the drive nut have a slightly larger diameter than the cap nut. This prevents the tooling member from catching on the cap nut during insertion of the fastener within the tooling member. Although other configurations are possible under the present invention, such as polygonal configurations or surfaces having engagement structures, robotic instruments or other tooling can easily grasp the outer cylindrical surface of the drive nut 24 and hold it in a stationary position while simultaneously grasping the outer surface of the cap nut 26 and rotate it so as to cause rotation of the corebolt 22 and engagement of the fastening mechanism.

The filly assembled fastener 10 is shown in FIG. 1 and includes the integral drive nut and cap nut. Again, fasteners having different bolt sizes can be utilized with the present invention by maintaining the outer surface configurations of the cap nut 26 and drive nut 24 and providing larger diameter bores 66,62 therethrough respectively to accommodate corebolts having larger diameters. Thus, as shown in FIGS. 3 through 5, the fastener 10 can be inserted through the aligned apertures of a plurality of workpieces 12,14 to fasten the workpieces together.

In operation, and as best shown in FIGS. 3 through 5, the fastener 10 of the present invention is provided fully assembled to clamp workpieces 12,14 together. As shown in FIG. 3, the inner end of the assembled fastener 10 is inserted into aligned apertures located in workpieces 12,14. The frustro-conically shaped inner portion of the fastener body head 30 is nested within the frustro-conical recess in the outer workpiece 12 so that the fastener 10 can be installed flush relative to the outer surface 16 of the outer workpiece 12. It is noted that no specific head configuration and outer workpiece surface is required and numerous configurations could be utilized to properly fasten the workpieces together, whether such engagement is flush or not with respect to the outer surface of the outer workpiece.

When head 30 of the fastener body 20 rests on the outer surface 16 of the outer workpiece 12 and the tapered nose 40 projects inwardly beyond the inner surface 18 of the inner workpiece 14 as shown in FIG. 3, corebolt 22 may be turned in one direction relative to the fastener body 20 to set the fastener in place and clamp the workpieces 12,14 together.

As best shown in FIG. 4, to engage the fastener 10 of the present invention, the installation tool, which can be a hand-held tool, a robotic instrument, or other installation tool, is moved axially onto the fastener 10. The installation tools non-rotating fitting 72 engaging the drive nut 24 and holds it and the fastener body 20 stationary while the rotary tooling member 74 engages the cap nut 26 to turn it and the pintail and corebolt in a direction to set the fastener 10. And while the dimensions of fastener as illustrated herein may vary, the outer surfaces of the cap nut and drive nut are preferably each of constant dimensions, regardless of the diameters of the corebolts upon which they are mounted so that the installation tooling does not have to be changed to install a different sized fastener.

As the rotary tooling member 74 rotates the cap nut 26, the corebolt 22 rotates within the fastener body 20 causing threaded engagement between the threaded portion 44 of the corebolt 22 and the threaded bore 56 of the end nut 52 to move the end nut 52 in an axial outward direction along the threaded portion 44 of the corebolt 22. The fastener body 20 is held stationary within the aligned apertures of the workpieces 12,14 due to the engagement between the non-rotating tooling member 72, the drive nut 24, and the fastener body head 30.

While the corebolt 22 is rotated, the end nut 52 is threadedly drawn axially outwardly along the threaded portion 44 of the corebolt 22 and forces the deformable sleeve 38 into engagement with the tapered nose 40 of the fastener body 20. As the end nut 52 continues to be drawn along the threaded portion 44 of the corebolt 22, the deformable sleeve 38 deforms over the taper nose 40 of the fastener body 20 and is prevented from rotational movement by the knurled portion. The deformable sleeve 38 fully sets against the inner surface 18 of the inner workpiece 14 and the head 30 of the fastener body 20 fully sets against the outer surface 16 of the outer workpiece 12 to securely connect the two workpieces 14,16.

As shown in FIG. 5, once the deformable sleeve 38 fully sets against the inner surface 18 of the inner workpiece 14, torque on the pintail 51 causes shear along the localized weakened region or break groove 50 located axially along the corebolt 22. This torque shears the pintail 51 at that break groove 50 that is flush with the fastener body head 30. Such a break groove 50 does not fail until a suitable amount of torque is exerted on the pintail 51 by the rotating tooling member 74 to cause failure. The once integral cap nut 26 and drive nut 24 assembly is now detached from the fastener 10 and can be discarded. The tooling member can release the detached cap nut and drive nut assembly and be free to engage another fastener having an integral drive nut and cap nut configuration.

Thus, the constant outer surface dimensions of the drive nut and cap nut advantageously enable use of a single installation tool to install fasteners of various sizes, without necessity to change the non-rotating fitting and the rotary tooling member of the tool. Further, providing an integral drive nut and cap nut insures that the fastener is on center when driving the fastener, unlike the prior art. Because the cap nut is integral to the fastener, there is no misalignment with the tooling member. Further, because the drive nut and cap nut are preferably cylindrical in shape, there is no tooling adjustment required to catch the wrenching surfaces in the appropriate orientation. The fastener of the present invention provides an already perfect in-line interaction between the cap nut, the drive nut, the fastener, and the tooling member when the fastener is picked up. This promotes the ability of robotic installation tools to properly place and fastener the fasteners. Further, given the construction of the present invention, the fastener is more easily retained in the tooling member before, during, and after installation.

Therefore, changing of the fitting and wrench bit of the installation tool is avoided completely, as is the need to use more than one installation tool should each tool be equipped with a different size fitting and wrench bit corresponding to a particular fastener size. The ability to use a single installation tool to install fasteners of various sizes enhances installation efficiency by significantly reducing the overall time and expense involved in installing the fasteners.

In many cases, the fastener may be installed by utilizing a hand-held, power driven installation tool. Other times, it may be desirable to install the fastener by automated or robotic installation tools. In either situation, the configuration of the outer surfaces of the cap nut and drive nut may be selected to facilitate installation of the fastener. For example, if manual installation is contemplated, the outer surface configuration of the drive nut and cap nut may be non-cylindrical, for example, hexagonal. The fitting and wrench bit of the installation tool, of course, would have a corresponding non-cylindrically or hexagonally shaped surface for engaging the drive nut and cap nut respectively. On the other hand, if robotic installation of the fastener is contemplated, the outer surface configuration of the drive nut and cap nut may be cylindrical with the fitting and wrench bit of the installation tool having a corresponding cylindrical shaped engagement surface. These cylindrical shaped engagement surfaces easily align with and securely grab the drive nut or cap nut to set the fastener. This advantageously eliminates the need for rotational adjustment of the fitting and wrench bit to align with the drive nut and cap nut and greatly increases the speed at which the fasteners can be installed.

The invention has been described with reference to the preferred embodiment. Obviously, modifications and alternations will occur to others upon a reading and understanding of this specification. Specifically, one could utilize the integral drive nut configuration with any number of corresponding blind fastener mechanisms, as addressed in the claims appended hereto. The claims as follows are intended to include all modifications and alterations insofar as they come within the scope of the claims or the equivalents thereof.

Having thus described the invention, I claim:

1. A fastener for mounting a plurality of workpieces in overlapping outer and inner relation through aligned openings therethrough, said fastener comprising:
a fastener body received within the aligned openings in the workpieces and having an inner end projecting inwardly beyond the inner workpiece and an enlarged body head for engagement with the outer surface of the outer workpiece, said fastener body having an axial bore therethrough,
a corebolt passing through said fastener body bore and having an externally threaded portion at its inner end;
an integral drive nut having an axial unthreaded bore therethrough, said drive nut configured to fit around the outer end of said corebolt and in contact with said body head to restrain said fastener body from turning within the workpieces;
a deformable sleeve configured to fit around said inner end of said corebolt and in contact with said inner end of said fastener body; and
an end nut having a threaded bore for engaging said threaded portion of said corebolt, said end nut in contact with said deformable sleeve so that upon holding said drive nut stationary and rotating said corebolt, said end nut is drawn along said threaded portion of said corebolt and forces said deformable sleeve to a fully set condition in overlying contact with the inner surface of the inner workpiece.

2. The fastener of claim 1 wherein said corebolt has a break groove provided at an axial location thereon and positioned substantially flush with the outer surface of said body head so that upon the fastener being fully set the corebolt shears off and the outer end of said corebolt and said integral drive nut are removed from the fastener.

3. The fastener of claim 2 wherein said drive nut further comprises at least one downwardly extending projection which engage said fastener body head to prevent the rotation of said body when said drive nut is held stationary.

4. The fastener of claim 3 wherein said fastener body head further comprises at least one notch formed therein which engages said at least one projection to prevent the rotation of said body when said drive nut is held stationary.

5. The fastener of claim 4 wherein said fastener body head comprises a frustro-conical shape capable of nested engagement with a confronting frustro-conical shape in the outer surface of the outer workpiece.

6. The fastener of claim 1 wherein the end nut includes a thread lock for locking the end nut to the externally threaded portion of the corebolt upon setting of the fastener.

7. The fastener of claim 1 wherein the end nut has a knurled portion and engages the inner end portion of the sleeve and wherein the inner end of the fastener body is conically shaped and has an knurled exterior surface that engages the outer end portion of the sleeve.

8. A fastener for mounting a plurality of workpieces in overlapping outer and inner relation through aligned openings therethrough, said fastener comprising:
a fastener body received within the aligned openings in the workpieces and having an inner end projecting inwardly beyond the inner workpiece and an enlarged body head for engagement with the outer surface of the outer workpiece, said fastener body having an axial bore therethrough,
a corebolt passing through said fastener body bore and having an externally threaded portion at its inner end;
an integral drive nut having an axial unthreaded bore therethrough, said drive nut configured to fit around the outer end of said corebolt and in contact with said body head to restrain said fastener body from turning within the workpieces;
a deformable sleeve configured to fit around said inner end of said corebolt and in contact with said inner end of said fastener body; and
a end nut having a threaded bore for engaging said threaded portion of said corebolt, said end nut in contact with said deformable sleeve; and
a cap nut mounted to the outer end of said corebolt and urging said drive nut into contact with said body head so that upon holding said drive nut stationary and rotating said cap nut, said corebolt within said stationary fastener body rotates thereby drawing said end nut along said corebolt and forcing said deformable sleeve to a fully set condition in overlying contact with the inner surface of the inner workpiece.

9. The fastener of claim 8 wherein said corebolt has a break groove provided at an axial location thereon and positioned substantially flush with the outer surface of said body head so that upon the fastener being fully set the corebolt shears off and the outer end of said corebolt, said cap nut, and said integral drive nut are removed from the fastener.

10. The fastener of claim 9 wherein said drive nut further comprises at least one downwardly extending projection which engage said fastener body head to prevent the rotation of said body when said drive nut is held stationary.

11. The fastener of claim 10 wherein said fastener body head further comprises at least one notch formed therein which engages said at least one projection to prevent the rotation of said body when said drive nut is held stationary.

12. The fastener of claim 11 wherein said fastener body head comprises a frustro-conical shape capable of nested engagement with a confronting frustro-conical shape in the outer surface of the outer workpiece.

13. The fastener of claim 8 wherein the end nut has a knurled portion and engages the inner end portion of the sleeve and wherein the inner end of the fastener body is conically shaped and has an knurled exterior surface that engages the outer end portion of the sleeve.

14. A blind fastener having a universal retention and driving assembly, said assembly comprising:
a fastener body having an body head and an axial bore therethrough;
a corebolt passing through said fastener body bore and having an outer end thereof extending above said body head;
an integral drive nut having an axial unthreaded bore therethrough, said drive nut configured to fit around the outer end of said corebolt and in contact with said body head to restrain said fastener body from turning during rotation of said corebolt; and
a cap nut mounted to the outer end of said corebolt and urging said drive nut into contact with said body head.

15. The fastener of claim 14 wherein said corebolt has a break groove provided at an axial location thereon and positioned substantially flush with the outer surface of said body head so that upon the fastener being fully set the corebolt shears off and the outer end of said corebolt, said cap nut, and said integral drive nut are removed from the fastener.

16. The blind fastener of claim 15 wherein the outer surface of said drive nut is cylindrical in configuration.

17. The blind fastener of claim 15 wherein the outer surface of said cap nut is cylindrical in configuration.

18. A fastener for mounting a plurality of workpieces in overlapping outer and inner relation through aligned openings therethrough, said fastener comprising:
a fastener body for receipt within the aligned openings in the workpieces and having an inner end projecting inwardly beyond the inner workpiece and an enlarged body head for engagement with the outer surface of the outer workpiece, said fastener body having an axial bore therethrough,
a corebolt passing through said fastener body bore; and
an integral drive nut having an axial unthreaded bore therethrough, said drive nut configured to fit around the outer end of said corebolt and in contact with said body head, said drive nut including a deformable portion which deforms against said fastener body head during installation of said drive nut to restrain said fastener body from turning within the workpieces when said drive nut is held stationary.

19. The fastener of claim 18 wherein said fastener body head includes at least on notch that receives a portion of said deformable portion of said drive nut thereby causing positive mechanical engagement between said drive nut and said fastener body head.

20. A fastener for mounting a plurality of workpieces in overlapping outer and inner relation through aligned openings therethrough, said fastener comprising:
a fastener body for receipt within the aligned openings in the workpieces and having an inner end projecting inwardly beyond the inner workpiece and an enlarged body head for engagement with the outer surface of the outer workpiece, said fastener body having an axial bore therethrough,
a corebolt passing through said fastener body bore; and
an integral drive nut having an axial unthreaded bore therethrough, said drive nut configured to fit around the outer end of said corebolt and in contact with said body head to restrain said fastener body from turning within the workpieces when said drive nut is held stationary.

21. A method of fastening overlapped outer and inner workpieces using a blind fastener of the type having a fastener body having an body head and an axial bore therethrough, a corebolt passing through the fastener body bore and having an outer end thereof extending above the body head, an integral drive nut having an axial unthreaded bore configured to fit around the outer end of the corebolt, and a cap nut mounted to the outer end of the corebolt and urging the drive nut into contact with the body head, said method comprising:
inserting the blind fastener through aligned openings in the workpieces to be fastened together until the body head engages an outer surface of the outer panel;
gripping the drive nut to hold it against rotation and thereby holding the fastener body against rotation;
applying torque to the cap nut to turn the corebolt in the one direction until the blind fastener achieves a fully set condition overlying the inner surface of the inner panel; and
applying additional torque to the cap nut after the fastener has been fully set so as to shear the corebolt thereby removing the outer end of the corebolt, the cap nut, and the drive nut from the fastener.
